(19) United States
(12) Patent Application Publication
(10) Pub. No.: US 2009/0247449 A1
(43) Pub. Date: Oct. 1, 2009

(54) DELIVERY PARTICLE

(76) Inventors: John Allen Burdis, Upon Tyne (GB); David William York, Upon Tyne (GB); Daniel Ning Geng Law, Beijing (CN); Brian Vincent, Henleaze (GB); Herley Casanova Yepes, Medellin (CO)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/405,325

(22) Filed: Mar. 17, 2009

Related U.S. Application Data
(60) Provisional application No. 61/070,846, filed on Mar. 26, 2008.

(51) Int. Cl. C11D 17/00

(52) U.S. Cl. 510/445

(57) ABSTRACT

The present application relates to particles, compositions comprising such particles, and processes for making and using such particles and compositions. Such particles minimize or eliminate certain drawbacks of encapsulated benefit agents.

When employed in compositions, for example, cleaning or fabric care compositions, such particles increase the efficiency of benefit agent delivery, there by allowing reduced amounts of benefit agents to be employed. In addition to allowing the amount of benefit agent to be reduced, such particles allow a broad range of benefit agents to be employed.

### CROSS-REFERENCE TO RELATED APPLICATIONS

This application claims priority under 35 U.S.C. §119(e) to U.S. Provisional Application Ser. No. 61/070,846, filed Mar. 26, 2008.

### FIELD OF INVENTION

The present application relates to particles, compositions comprising such particles, and processes for making and using such particles and compositions.

### BACKGROUND OF THE INVENTION

Benefit agents, such as perfumes, silicones, waxes, flavors, vitamins and fabric softening agents, are expensive and generally less effective when employed at high levels in personal care compositions, cleaning compositions, and fabric care compositions. As a result, there is a desire to maximize the effectiveness of such benefit agents. One method of achieving this objective is to improve the delivery efficiencies of such benefit agents. Unfortunately, it is difficult to improve the delivery efficiencies of benefit agents as such agents may be lost due to the agents' physical or chemical characteristics, or such agents may be incompatible with other compositional components or the situs that is treated.

In an effort to improve the delivery efficiencies of benefit agents, the industry, in many cases, encapsulated such benefit agents with organic materials. Unfortunately, in certain applications, a large portion of such encapsulated benefit agent leaks from the capsule thus, there is a need for a particle that minimizes or eliminates such drawbacks.

### SUMMARY OF THE INVENTION

The present application relates to particles, compositions comprising such particles, and processes for making and using such particles and compositions. Such particles minimize or eliminate certain drawbacks of encapsulated benefit agents.

### DETAILED DESCRIPTION OF THE INVENTION

### Definitions

As used herein “consumer product” means baby care, beauty care, fabric & home care, family care, feminine care, health care, snack and/or beverage products or devices intended to be used or consumed in the form in which it is sold, and not intended for subsequent commercial manufacture or modification. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition, and water purification; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee.

As used herein, the term “cleaning composition” includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners; hair shampoos and hair-rinses; shower gels and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists.

As used herein, the term “fabric care composition” includes, unless otherwise indicated, fabric softening compositions, fabric enhancing compositions, fabric freshening compositions and combinations there of.

As used herein, the phrase “benefit agent delivery particle” encompasses microcapsules including perfume microcapsules.

As used herein, the terms “particle”, “benefit agent delivery particle”, “capsule” and “microcapsule” are synonymous.

As used herein, the articles including “a” and “an” when used in a claim, are understood to mean one or more of what is claimed or described.

As used herein, the terms “include”, “includes” and “including” are meant to be non-limiting.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Benefit Agent Delivery Particle

Applicants discovered that the problem of achieving effective and efficient benefit agent delivery can be solved in an economical manner when the benefit agent delivery particles and consumer products disclosed below are employed.

In one aspect, a benefit agent delivery particle comprising a core material comprising a benefit agent and a shell material comprising a water insoluble inorganic material and, optionally, an organic material, said shell material at least partially surrounding said core material or, even in one aspect, surrounding said core, is disclosed.

In one aspect of the aforementioned benefit agent delivery particle, said water insoluble inorganic material may comprise, a material selected from the group consisting of water insoluble carbonates, water insoluble sulphates, water insoluble silica, water insoluble silicates and mixtures thereof; for example, water insoluble carbonates, water insoluble silicates and mixtures thereof.

In one aspect of the aforementioned benefit agent delivery particle, said shell of said benefit agent delivery particle may comprise a polymer that is the reaction product of:

a.) a monomer soluble in the benefit agent delivery particle's benefit agent, said monomer soluble in said benefit agent includes, but is not limited to, a material that may be selected from the group consisting of polyacid chlorides, for example, trimesoyl chloride, terapthaloyl chloride, sebacoyl chloride and mixtures thereof; polychlororformates, for example, 1,3,5 benzene trischloroformate, ethylene bischloroformate and mixtures thereof; polyisocyanates, for example, isophorone diisocyanate, toluene diisocyanate, hexamethylene diisocyanate, methylene diphenylisocyanate and polymethylene poly-phenylisocyanate, and mixtures thereof; polysulphonyl chlorides, for example, 1,3-benzenesulfonyl dichloride and 1,3,5-benzenesulfonyl trichloride; and mixtures thereof; and

b.) a monomer soluble in water, said monomer soluble in water includes, but is not limited to, a material that may be selected from the group consisting of polyamines, for example, diethylenetriamine, hexamethylenediamine and mixtures thereof; polyols, for example, ethylene glycol, polyesters, polyethers and mixtures thereof; polyelectrolytes, for example, polycations including, but not limited to, chitosan, polyanions, for example, alginic acid, alkali metal salts of alginic acid such as sodium salts and mixtures thereof, and mixtures thereof; polysaccharides, for example, starch; proteins, including, but not limited to, alkali metal salts of proteins such as sodium caseinate; and mixtures thereof.

In one aspect of the aforementioned benefit agent delivery particle, said benefit agent may comprise a material selected from the group consisting of perfumes, fungicides, malodour counteractants, and mixtures thereof. Suitable perfumes include, but are not limited to, perfumes that may comprise a moiety selected from the group consisting of alcohols, aldehydes, ketones, ethers, acids, acetals, ketals, nitriles, esters, saturated hydrocarbons, aliphatic hydrocarbons, aromatic hydrocarbons, carbocylic hydrocarbons, heterocyclic hydrocarbons and mixtures thereof. Suitable malodour counteractants include, but are not limited to, malodour counteractants, that may be selected from the group consisting of Arbor Vitae, chlorophyll, cyclodextrins, flavanoids, Hinoki oil, parsley extract, phthalocyanine, saponin, tea tree oil or the zinc salt of ricinoleic acid and mixtures thereof.

In one aspect of the aforementioned benefit agent delivery particle, said shell's thickness may range from about 0.1 microns to about 10 microns, from about 1 microns to about 5 microns, or even from about 1.25 to about 2.5 microns.

In one aspect of the aforementioned benefit agent delivery particle, said benefit agent delivery particle's mean particle size may range from about 1 microns to about 100 microns, from about 10 microns to about 60 microns, or even from about 30 microns to about 40 microns.

In one aspect of the aforementioned benefit agent delivery particle, said benefit agent delivery particle may have a core to wall weight ratio of from about 95:5 to about 40:60, from about 90:10 to about 70:30, or even from about 85:15 to about 75:25.

In one aspect of the aforementioned benefit agent delivery particle, said benefit agent delivery particle of may have a leakage index of from about 0 to about 10, from about 0.0001 to about 10, from about 0.001 to about 3, or even from about 0.001 to about 0.01.

In one or more aspects, the aforementioned benefit agent delivery particle may have any combination of the benefit agent delivery parameters disclosed above.

In addition to the teachings above, useful wall materials include materials selected from the group consisting of insoluble inorganic salts, silicates, polyamides, polystyrenes, polyisoprenes, polycarbonates, polyesters, polyacrylates, polyureas, polyurethanes, polyolefins, polysaccharides, epoxy resins, vinyl polymers, and mixtures thereof. In one aspect, useful wall materials include materials that are sufficiently impervious to the core material and the materials in the environment in which the benefit agent delivery particle will be employed, to permit the delivery benefit to be obtained. Suitable impervious wall materials include materials selected from the group consisting of reaction products of two or more inorganic salts, such as sodium carbonate and calcium chloride and polyamines with one or more polyacid chlorides, such as diethylene triamine and trimesoyl chloride.

In addition to the teachings above, useful core materials include perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers and anti-foaming agents, UV protection agents for fabrics and skin, sun fade inhibitors, anti-allergenic agents, enzymes, water proofing agents, fabric comfort agents, shrinkage resistance agents, stretch resistance agents, stretch recovery agents, skin care agents, glycerin, and natural actives such as aloe vera, vitamin E, shea butter, cocoa butter, and the like, brighteners, antibacterial actives, antiperspirant actives, cationic polymers and mixtures thereof. In one aspect, said perfume raw material is selected from the group consisting of alcohols, ketones, aldehydes, esters, ethers, nitrites alkenes. In one aspect the core material comprises a perfume. In one aspect, said perfume comprises perfume raw materials selected from the group consisting of alcohols, ketones, aldehydes, esters, ethers, nitrites alkenes and mixtures thereof. In one aspect, said perfume may comprise a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3 and mixtures thereof. Perfume raw materials having a boiling point B.P. lower than about 250° C. and a ClogP lower than about 3 are known as Quadrant I perfume raw materials, perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. In one aspect, said perfume comprises a perfume raw material having B.P. of lower than about 250° C. In one aspect, said perfume comprises a perfume raw material selected from the group consisting of Quadrant I, II, III perfume raw materials and mixtures thereof. In one aspect, said perfume comprises a Quadrant III perfume raw material. Suitable Quadrant I, II, III and IV perfume raw materials are disclosed in U.S. Pat. No. 6,869,923 B1.

In one aspect, said perfume comprises a Quadrant IV perfume raw material. While not being bound by theory, it is believed that such Quadrant IV perfume raw materials can improve perfume odor “balance”. Said perfume may comprise, based on total perfume weight, less than about 30%, less than about 20%, or even less than about 15% of said Quadrant IV perfume raw material.

The perfume raw materials and accords may be obtained from one or more of the following companies Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.), Millennium Specialty Chemicals (Olympia Fields, Ill.), Polarone International (Jersey City, N.J.), Fragrance Resources (Keyport, N.J.), and Aroma & Flavor Specialties (Danbury, Conn.).

### Process of Making Benefit Agent Delivery Particles

In one aspect, a process of making a benefit agent delivery particle comprising a shell and a core, said core comprising a benefit agent, said process comprising:

a. forming an emulsion comprising a benefit agent and an inorganic material, in one aspect, said inorganic material may have a particle size of from about 10 to 1000 times smaller than said benefit agent droplet or even from about 100 to about 500 times smaller than said benefit agent droplet;

b. simultaneously combining at least two inorganic materials with said emulsion. In one aspect, said inorganic materials may comprise CaCl₂ and Na₂CO₃.

Further teachings concerning the process of making said benefit agent delivery particle include the teachings of the examples of the present specification as well as the teachings below.

Disperse the inorganic material in water. Thoroughly mix this dispersion with a benefit agent. Add at least two inorganic materials concurrently

2) Interfacial polymerization. During step (a) a monomeric species which is soluble in the benefit agent is added to the benefit agent prior to the emulsification step. After the initial inorganic precipitation step the capsules are dispersed in a solution of a second monomer which is soluble in water. The two monomers react together at any available interfaces (gaps between the inorganic particles) to form a polymer which further restricts the leakage of the benefit agent from the capsule through these interfaces. Non-limiting examples of organic soluble monomers include materials selected from the group consisting of polyacid chlorides, polychloroformates, polyisocyanates and polysulphonyl chlorides. Non limiting examples of water soluble monomers are polyamines and polyols where polyols are compounds with multiple hydroxyl groups consisting of, but not limited to, polyesters and polyethers.
3) Leakage of the benefit agent can be further reduced by coating of the inorganic capsules. In one aspect the coating species may be selected from the group of polycations, such as chitosan, polyanions such as alginates, silicates, starches or salts of proteins such as sodium caseinate.

Such materials can be obtained from CP Kelco Corp. of San Diego, Calif., USA; Degussa AG or Dusseldorf, Germany; BASF AG of Ludwigshafen, Germany; Rhodia Corp. of Cranbury, N.J., USA; Baker Hughes Corp. of Houston, Tex., USA; Hercules Corp. of Wilmington, Del., USA; Agrium Inc. of Calgary, Alberta, Canada, ISP of New Jersey U.S.A, Sigma Aldrich, Milwaukee, Wis.

Suitable equipment for use in the processes disclosed herein may include continuous stirred tank reactors, homogenizers, turbine agitators, recirculating pumps, paddle mixers, ploughshear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., USA), Arde Barinco (New Jersey, USA).

### Compositions Comprising Benefit Agent Delivery Particles

Applicants' compositions comprise an embodiment of the particle disclosed in the present application. In one aspect, said composition is a consumer product. While the precise level of particle that is employed depends on the type and end use of the composition, a composition may comprise, in one aspect, based on total composition weight, from about 0.001% to about 10%, from about 0.001% to about 5%, from about 0.001% to about 1%, from about 0.001% to about 0.5%, from about 0.001% to about 0.2% or even from about 0.001% to about 0.1% percent of any benefit agent delivery particle disclosed in the present specification.

In one aspect, a consumer product that may comprise, based on total consumer product weight, from about 0.001% to about 10%, from about 0.001% to about 5%, from about 0.001% to about 1%, from about 0.001% to about 0.5%, from about 0.001% to about 0.2% or even from about 0.001% to about 0.1% percent of any benefit agent delivery particle disclosed in the present specification.

In one aspect, a cleaning composition may comprise, from about 0.1 to about 1 weight % of benefit agent delivery particle based on total cleaning composition weight of such particle. In one aspect, a fabric treatment composition may comprise, based on total fabric treatment composition weight, from about 0.01 to about 10% of benefit agent delivery particle.

Aspects of the invention include the use of the particles of the present invention in laundry detergent compositions (e.g., TIDE™), hard surface cleaners (e.g., MR CLEAN™), automatic dishwashing liquids (e.g., CASCADE™), dishwashing liquids (e.g., DAWN™), and floor cleaners (e.g., SWIFFER™). Non-limiting examples of cleaning compositions may include those described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445. The cleaning compositions disclosed herein are typically formulated such that, during use in aqueous cleaning operations, the wash water will have a pH of between about 6.5 and about 12, or between about 7.5 and 10.5. Liquid dishwashing product formulations typically have a pH between about 6.8 and about 9.0. Cleaning products are typically formulated to have a pH of from about 7 to about 12. Techniques for controlling pH at recommended usage levels include the use of buffers, alkalis, acids, etc., and are well known to those skilled in the art.

Fabric treatment compositions disclosed herein typically comprise a fabric softening active (“FSA”). Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components that are supplied via Applicants' delivery particles and other components of products previously disclosed herein. The precise nature of these additional components, and levels of incorporation thereof, will depend on the physical form of the composition and the nature of the operation for which it is to be used. Suitable adjunct materials include, but are not limited to, polymers, for example cationic polymers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' cleaning and fabric care compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. However, when one or more adjuncts are present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Preferred transition-metals in the instant transition-metal bleach catalyst include manganese, iron and chromium. Preferred MRL's herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

### Processes of Making and Using Compositions

The compositions of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use and Treated Situs

Compositions containing the benefit agent delivery particle disclosed herein can be used to clean or treat a situs inter alia a surface or fabric. Typically at least a portion of the situs is contacted with an embodiment of Applicants' composition, in neat form or diluted in a liquor, for example, a wash liquor and then the situs may be optionally washed and/or rinsed. In one aspect, a situs is optionally washed and/or rinsed, contacted with a particle according to the present invention or composition comprising said particle and then optionally washed and/or rinsed. For purposes of the present invention, washing includes but is not limited to, scrubbing, and mechanical agitation. The fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

In one aspect, a situs treated with any benefit agent delivery particle disclosed in the present specification and/or any composition, including but not limited to a consumer product disclosed in the present specification, is disclosed.

### TEST METHODS

It is understood that the test methods that are disclosed in the Test Methods Section of the present application should be used to determine the respective values of the parameters of Applicants' invention as such invention is described and claimed herein.

(1) Fracture Strength
a.) Place 1 gram of particles in 1 liter of distilled deionized (DI) water.
b.) Permit the particles to remain in the DI water for 10 minutes and then recover the particles by filtration.
c.) Determine the average rupture force of the particles by averaging the rupture force of 50 individual particles. The rupture force of a particle is determined using the procedure given in Zhang, Z.; Sun, G; “Mechanical Properties of Melamine-Formaldehyde microcapsules,” J. Microencapsulation, vol 18, no. 5, pages 593-602, 2001. Then calculate the average fracture pressure by dividing the average rupture force (in Newtons) by the average cross-sectional area (as determined by Test Method 1 above) of the spherical particle (πr², where r is the radius of the particle before compression).
d) For a capsule slurry the sample is divided into three particle size fractions covering the particle size distribution. Per particle size fraction about 10 fracture strengths are determined.

(2) ClogP
The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor, and C. A. Ramsden, Eds. P. 295, Pergamon Press, 1990, incorporated herein by reference). ClogP values may be calculated by using the “CLOGP” program available from Daylight Chemical Information Systems Inc. of Irvine, Calif. U.S.A.

(3) Boiling Point
Boiling point is measured by ASTM method D2887-04a, “Standard Test Method for Boiling Range Distribution of Petroleum Fractions by Gas Chromatography,” ASTM International.

(4) Leakage of Benefit Agent
Obtain 1.5 g of capsules and add 50 mLs of deionised water and mix to disperse the capsules in the water. Add 50 mLs of hexane to the dispersion. After 5, 30, 60, 90, 120 and 150 minutes take 3 mLs of the hexane layer and determine the UV absorbance of the hexane aliquot at 270 nm (for perfume). Perform a UV calibration using the encapsulated benefit agent. From the calibration convert the absorbances obtained from the analysis of the capsules into % benefit agent. Plot % benefit agent vs. time for the capsules. The slope of this graph is a measure of the rate of release of the benefit agent from the capsule. For purposes of this test, the resulting rate of release is used to define leakage.

(5) Mean Particle Size
Equipment: Sympatec Helos, Rodos & Vibri supplied by Sympatec GmbH, System-Partikel-Technik, Burgstatterstraβe 6, D-38678 Clausthal-Zellerfeld, Germany. The equipment setup (Helos, Rodos & Vibri) as described in manual HELOS 1, issue date January 1995. Software setup and sample analysis is performed using Windox software (Windox 5.1.1.5, copyright date 2003) in the WINDOX manual.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### 50 wt % Core/50 wt % Wall Calcium Carbonate Microcapsules

A 10% dispersion of the nano calcium carbonate (Omya UK, Derbyshire, UK) in tap water is prepared. The dispersion is thoroughly mixed, the solids are allowed to settle out and the liquid portion is decanted. The process is repeated until the surface tension of the liquid phase becomes constant. 8 grams of benefit agent (perfume) is added to 12 grams of the final dispersion and mixed vigorously to produce an oil in water emulsion. 20 mL of a 4M solution of calcium chloride (Sigma Aldrich, Milwaukee, Wis.) and 40 mL of 2M sodium carbonate (Sigma Aldrich, Milwaukee, Wis.) are simultaneously titrated, at a rate of approximately 1 mL/min for calcium chloride and 2 mL minute for sodium carbonate into the oil in water emulsion to produce microcapsules. The microcapsules are then decanted from the bulk liquor. Such microcapsules are tested in accordance with the Test Methods of the present specification are found to have the following properties:

| | Mean | Fracture | |
|---|---|---|---|
| Particle | Particle | Strength | |
| batch | Size | Determination | Leakage |
| Calcium | 32 micron | 32 micron: | <0.01% |
| Carbonate | | 2 Mpa | perfume/hour |

### Example 2

### Inverse Titration of 50 wt % Core/50 wt % Wall Calcium Carbonate Microcapsules

6 mL of the carbonate microcapsules from Example 1 are added to 4 mL of calcium chloride solution to form a suspension. The suspension is titrated dropwise into 20 mL of sodium carbonate. Approximately 70% of the suspension's liquor is decanted and the remaining suspension is titrated dropwise into 20 mL of calcium chloride solution. The bulk liquor is then decanted to leave a concentrated suspension of microcapsules. Such microcapsules are tested in accordance with Test Method Four (4) of the present specification “Leakage of Benefit Agent” and are found to have an average leakage rate of 0.005%.

### Example 3

### Interfacial Polymerization of 50 wt % Core/50 wt % Wall Calcium Carbonate Microcapsules

0.005 g of trimesoyl chloride is added to the 8 grams of benefit agent and mixed to ensure dissolution. The procedure of Example 1 is then followed to produce microcapsules that have the following parameters 50 wt % Core/50 wt % Wall Calcium Carbonate.

Next, 1 g of diethylene triamine is dissolved in 20 mLs of water to form a solution. Such solution and the aforementioned capsules are combined and mixed gently. Such microcapsules are tested in accordance with Test Method Four (4) of the present specification “Leakage of Benefit Agent” and are found to have an average leakage rate of 0.002%.

### Example 4

### Sodium Caseinate Coated Inorganic Microcapsules

Microcapsules are prepared in accordance with Example 1, except, the following titration step replaces the final titration step of Example 1:

60 mL of a 1.5M solution of sodium carbonate containing 2% (by weight) sodium casienate and 60 mL of a 1.5M solution of calcium chloride (Sigma Aldrich, Milwaukee, Wis.) are titrated simultaneously into the oil in water emulsion of Example 1 at a rate of approximately 1 mL/min to produce capsules. The microcapsules are then decanted from the bulk liquor. Such capsules are tested in accordance with Test Method Four (4) of the present specification “Leakage of Benefit Agent” and are found to have an average leakage rate of 0.01%.

### Example 5

### Silicate Coated Carbonate Microcapsules

An oil in water emulsion is produced in accordance with Example 1. Next, 60 mL of a 1.5M solution of calcium chloride (Sigma Aldrich, Milwaukee, Wis.) and 60 mL of a 1.5M solution of a sodium carbonate (Sigma Aldrich, Milwaukee, Wis.) are simultaneously titrated into the aforementioned oil in water emulsion at a rate of approximately 1 mL/min to form a suspension containing microcapsules. Then, 20 ml of a 0.5M sodium silicate solution and 20 mL of a 0.5M calcium chloride are simultaneously titrated in to the suspension containing capsules. The microcapsules are then decanted from the bulk liquor. Such microcapsules are tested in accordance with Test Method Four (4) of the present specification “Leakage of Benefit Agent” and are found to have an average leakage rate of 0.01%.

### Example 6

Non-limiting examples of product formulations containing the microcapsules of the present invention (for example, microcapsules produced in accordance with the previous examples) are summarized in the following table.

Microcapsules in Liquid Detergent Formulations

| | % w/w liquid laundry detergent composition | | | | | |
|---|---|---|---|---|---|---|
| Component | A | B | C | D | E | F |
| C25 AE1.8S | 8.9 | 21 | 21.7 | 19 | 14.2 | 13.7 |
| HLAS | 2 | 28 | 2.9 | 2 | 5.7 | 5.5 |
| MSAS | 2.9 | 6.8 | 7.0 | 5 | 3.1 | 3 |
| NI 24-9 | 0.4 | 0.8 | 1.2 | 1.2 | 8.5 | 8 |
| Citric Acid | 2.4 | 3.8 | 3.9 | 3.8 | 3.6 | 3.5 |
| Soap | 0.95 | 2 | 2.1 | 2 | 5.2 | 5 |
| Enzymes (e.g. Protease | 1.9 | 4.9 | 5.3 | 5.6 | 3.6 | 3.3 |
| 54.5 mg/g active, amylase) | | | | | | |
| Borax | 1 | 3 | 3.1 | 3 | 2.1 | 2 |
| Ca Formate | 0.07 | 0.08 | 0.08 | 0.08 | 0.08 | 0.08 |
| PA-Base | 0.3 | 0.6 | 0.6 | 0.6 | 1 | 1 |
| PE20 | 0.65 | 1.2 | 1.9 | 2.8 | 3.1 | 2 |
| Z96-70% | 0.8 | 1.6 | 1.7 | 0 | 1.2 | 2 |
| DTPA | 0.25 | 0.25 | 0.26 | 0.4 | 0.26 | 0.25 |
| Brightener | 0.1 | 0.2 | 0.31 | 0.3 | 0.25 | 0.2 |
| Stabilisers | 12.2 | 17.4 | 19.1 | 15.5 | 16.3 | 16.5 |
| Suds Suppressor | 0.01 | 0.01 | 0.01 | 0.01 | 0.01 | 0.01 |
| Perfume oil | 0.28 | 0.56 | 0.64 | 0.56 | 0.65 | 0.67 |
| Perfume microcapsules* | 0.28 | 0.56 | 0.64 | 0.56 | 0.65 | 0.67 |
| Misc | 0.21 | 0.3 | 0.21 | 0.3 | 0.21 | 0.21 |
| Balance Water | 64.4 | 6.94 | 27.35 | 37.29 | 30.29 | 32.41 |

*Microcapsule added as 45% active slurry. Core/wall ratio may range from 50/50 up to 70/30 and average particle diameter can range from 5 μm to 50 μm

### Example 7

### Microcapsules in Dry Laundry Formulations

| | % w/w granular laundry detergent composition | | | | | | |
|---|---|---|---|---|---|---|---|
| Component | A | B | C | D | E | F | G |
| Brightener | 0.1 | 0.1 | 0.1 | 0.2 | 0.1 | 0.2 | 0.1 |
| Soap | 0.6 | 0.6 | 0.6 | 0.6 | 0.6 | 0.6 | 0.6 |
| Ethylenediamine disuccinic acid | 0.1 | 0.1 | 0.1 | 0.1 | 0.1 | 0.1 | 0.1 |
| Acrylate/maleate copolymer | 1.5 | 1.5 | 1.5 | 1.5 | 1.5 | 1.5 | 1.5 |
| Hydroxyethane di(methylene | 0.4 | 0.4 | 0.4 | 0.4 | 0.4 | 0.4 | 0.4 |
| phosphonic acid) | | | | | | | |
| Mono-C₁₂₋₁₄ alkyl, di-methyl, | 0.5 | 0.5 | 0.5 | 0.5 | 0.5 | 0.5 | 0.5 |
| mono-hydroyethyl quaternary | | | | | | | |
| ammonium chloride | | | | | | | |
| Linear alkyl benzene | 0.1 | 0.1 | 0.2 | 0.1 | 0.1 | 0.2 | 0.1 |
| Linear alkyl benzene sulphonate | 10.3 | 10.1 | 19.9 | 14.7 | 10.3 | 17 | 10.5 |
| Magnesium sulphate | 0.4 | 0.4 | 0.4 | 0.4 | 0.4 | 0.4 | 0.4 |
| Sodium carbonate | 19.5 | 19.2 | 10.1 | 18.5 | 29.9 | 10.1 | 16.8 |
| Sodium sulphate | 29.6 | 29.8 | 38.8 | 15.1 | 24.4 | 19.7 | 19.1 |
| Sodium Chloride | 0.1 | 0.1 | 0.1 | 0.1 | 0.1 | 0.1 | 0.1 |
| Zeolite | 9.6 | 9.4 | 8.1 | 18 | 10 | 13.2 | 17.3 |
| Photobleach particle | 0.1 | 0.1 | 0.2 | 0.1 | 0.2 | 0.1 | 0.2 |
| Blue and red carbonate speckles | 1.8 | 1.8 | 1.8 | 1.8 | 1.8 | 1.8 | 1.8 |
| Ethoxylated Alcohol AE7 | 1 | 1 | 1 | 1 | 1 | 1 | 1 |
| Tetraacetyl ethylene diamine | 0.9 | 0.9 | 0.9 | 0.9 | 0.9 | 0.9 | 0.9 |
| agglomerate (92 wt % active) | | | | | | | |
| Citric acid | 1.4 | 1.4 | 1.4 | 1.4 | 1.4 | 1.4 | 1.4 |
| PDMS/clay agglomerates (9.5% | 10.5 | 10.3 | 5 | 15 | 5.1 | 7.3 | 10.2 |
| wt % active PDMS) | | | | | | | |
| Polyethylene oxide | 0.2 | 0.2 | 0.2 | 0.2 | 0.2 | 0.2 | 0.2 |
| Enzymes e.g. Protease (84 mg/g | 0.2 | 0.3 | 0.2 | 0.1 | 0.2 | 0.1 | 0.2 |
| active), Amylase (22 mg/g active) | | | | | | | |
| Suds suppressor agglomerate | 0.2 | 0.2 | 0.2 | 0.2 | 0.2 | 0.2 | 0.2 |
| (12.4 wt % active) | | | | | | | |
| Sodium percarbonate (having | 7.2 | 7.1 | 4.9 | 5.4 | 6.9 | 19.3 | 13.1 |
| from 12% to 15% active AvOx) | | | | | | | |
| Perfume oil | 0.5 | 0.5 | 0.5 | 0.5 | 0.5 | 0.5 | 0.5 |
| Solid perfume particles | 0.4 | 0 | 0.4 | 0.4 | 0.4 | 0.4 | 0.6 |
| Perfume microcapsules* | 1.3 | 2.4 | 1 | 1.3 | 1.3 | 1.3 | 0.7 |
| Misc | 0.1 | 0.1 | 0.1 | 0.1 | 0.1 | 0.1 | 0.1 |
| Balance Water | | | | | | | |

*Microcapsule added as 45% active slurry. Core/wall ratio may range from 50/50 up to 70/30 and average particle diameter can range from 5 μm to 50 μm

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A benefit agent delivery particle comprising a core material comprising a benefit agent and a shell material comprising a water insoluble inorganic material and, optionally, an organic material, said shell material at least partially surrounding said core material.

2. The benefit agent delivery particle of claim 1, wherein said water insoluble inorganic material comprises, a material selected from the group consisting of water insoluble carbonates water insoluble sulphates, water insoluble silica, water insoluble silicates and mixtures thereof.

3. The benefit agent delivery particle of claim 1, the shell of said benefit agent delivery particle comprising a polymer that is the reaction product of:
a.) a monomer soluble in said benefit agent, said monomer soluble in said benefit agent being selected from the group consisting of polyacid chlorides, polychlororformates, polyisocyanates, polysulphonyl chlorides, and mixtures thereof; and
b.) a monomer soluble in water, said monomer soluble in water being selected from the group consisting of polyamines, polyols, polyelectrolytes, polysaccharides, proteins, and mixtures thereof.

4. The benefit agent delivery particle of claim 1, wherein said benefit agent comprises a material selected from the group consisting of perfumes, fungicides, malodour counteractants, and mixtures thereof.

5. The benefit agent delivery particle of claim 1, wherein said shell surrounds said benefit agent.

6. The benefit agent delivery particle of claim 1 wherein said shell's thickness is from about 0.1 microns to about 10 microns.

7. The benefit agent delivery particle of claim 1 wherein said benefit agent delivery particle's mean particle size is from about 1 microns to about 100 microns.

8. The benefit agent delivery particle of claim 1 said benefit agent delivery particle having a core to wall weight ratio of from about 95:5 to about 40:60.

9. The benefit agent delivery particle of claim 1 having a leakage index of from about 0 to about 10.

10. A consumer product of comprising a benefit agent delivery particle according to claim 1.

11. A consumer product according to claim 10, said consumer product comprising, based on total consumer product weight, from about 0.001% to about 10%, of said benefit agent delivery particle.

12. A method of treating and/or cleaning a situs, said method comprising
a.) optionally washing and/or rinsing said situs;
b.) contacting said situs with a benefit agent delivery particle composition according to claim 1 and/or a consumer product according to claim 10; and
c.) optionally washing and/or rinsing said situs.

13. A situs treated with the benefit agent delivery particle according to claim 1 and/or consumer product of claim 10.

14. A process of making a benefit agent delivery particle comprising a shell and a core, said core comprising a benefit agent, said process comprising:
a. forming an emulsion comprising a benefit agent and an inorganic material, said inorganic material having a particle size of from about 10 to 1000 times smaller than said benefit agent droplet;
b. simultaneously combining at least two inorganic materials with said emulsion.
